(19) United States
(12) Patent Application Publication
(10) Pub. No.: US 2007/0027232 A1
(43) Pub. Date: Feb. 1, 2007

(54) Coating compositions incorporating nanotechnology and methods for making same

(75) Inventors: Richard J. Walsh JR., Montoursville, PA (US); Steven J. Sander, Cogan Station, PA (US)

Correspondence Address: HOFFMANN & BARON, LLP, 6900 JERICHO TURNPIKE, SYOSSET, NY, 11791, US

(73) Assignee: CHEMCOAT, INC.

(21) Appl. No.: 11/190,798

(22) Filed: Jul. 27, 2005

(51) Int. Cl. C08J 9/32

(52) U.S. Cl. 523/218; 524/492

(57) ABSTRACT

The present invention relates to coating compositions, particularly water-based coating compositions, which incorporate nanotechnology. More specifically, the water-based coating compositions may include: a binder; a plurality of hydrophobic silica particles; and a solvent. The coating compositions may be applied to a variety of different surfaces, such as, for example, metals, plastics and signs, among others to impart resistance to corrosion and/or deterioration over time, as well as good adhesion thereto.

### FIELD OF THE INVENTION

The present invention relates to coating compositions, particularly water-based coating compositions, which incorporate nanotechnology. More specifically, the present invention provides coating compositions including silica particles that may impart resistance to corrosion and/or deterioration to surfaces over time, as well as good adhesion thereto.

### BACKGROUND OF THE INVENTION

The surfaces of many objects that are exposed to outdoor weather conditions deteriorate over time. The moisture and salt in air, as well as sunlight, heat and numerous other environmental factors play a role in the deterioration of surfaces exposed to such outdoor conditions. For example, outdoor fixtures made of metals, road signs, building materials and auto and airplane parts, among others, are exposed to outdoor weather conditions. Many of these objects experience rust and other surface deterioration over time due to such exposure. Degradation caused by outdoor exposure may be aesthetically undesirable, as well as a problem for performance of many objects.

The art has seen attempts to provide suitable paints, coatings and the like which may be placed over the surface of an object which helps retard the corrosive effect of outdoor environment. These paints and coatings have not been entirely effective.

Coatings including silica particles have also been employed.

U.S. Pat. No. 5,820,920 to Huang discloses a colloidal silica coating. This coating retards the formation of water droplets on the surface to which it is applied. Such a coating is useful on surfaces that are designed for transparency or retroreflectiveness. However, the coating disclosed therein does not assist in retarding corrosion.

U.S. Pat. No. 5,637,636 to Cartwright et al. discloses an amorphous silica which can be used in paints and lacquers. The amorphous silica is used as a matting agent in thixotropic paints and lacquers for providing various finishes. The amorphous silica is not designed to retard rust or corrosion due to outdoor weather conditions.

International Publication No. WO 00/68330 describes an adhesive coating having fine ceramic particles such as silica. In this case, the incorporation of fine ceramic particles produces a modified resin, which has a structure capable of preventing entry of oxygen or moisture. Silica is not provided to enhance corrosive resistance.

Therefore, there is a need for compositions that may be used to coat the surfaces of objects to impart resistance to deterioration over time. Coatings that provide resistance to corrosion and/or deterioration from sunlight, moisture and heat are needed to coat a variety of different surfaces, thereby providing improved surface properties thereto. Such coatings would permit objects to be exposed to outdoor conditions for longer periods of time without substantially rusting or deteriorating.

### SUMMARY OF THE INVENTION

In some embodiments of the present invention, there is provided a water-based coating composition including: a binder; a plurality of hydrophobic silica particles; and a solvent.

Some embodiments provide a water-based paint composition including: an acrylic resin binder; a plurality of hydrophobic silica aerogels; an organic solvent; water; a pigment; and one or more components selected from: defoaming agents; surfactants; plasticizers; pH adjusting agents; thickening agents; rust inhibitors; fire retardants; carbon fibers; dispersants; and coalescents.

In some embodiments there is provided a water-based coating composition including: a binder; a plurality of hydrophobic silica particles; a solvent; and water. The composition is capable of resisting corrosion by fog for about 4000 to about 5000 hours when subjected to salt spray fog testing per ASTM B 117-03 and the composition is capable of resisting deterioration caused by exposure to light, heat and water for about 2500 to about 5000 hours when subjected to accelerated weathering testing per ASTM D 4587-01.

Some embodiments provide a method of imparting corrosion resistance to a surface, including the steps of: (a) providing an object having a surface to be coated; (b) providing a water-based coating composition which includes a binder, a solvent, water, a plurality of hydrophobic silica particles, and optionally one or more components selected from defoaming agents, surfactants, pH adjusters, thickening agents, plasticizers, rust inhibitors, pigments, fire retardants, carbon fibers, dispersants, and coalescents; and (c) applying the water-based coating composition to the surface, thereby imparting corrosion resistance thereto.

Some embodiments provide a method of preparing a water-based coating composition, including the steps of: (a) providing a premix including a first amount of water and a solvent; (b) providing a binder; (c) adding the premix to the binder under agitation; and (d) dissolving a plurality of hydrophobic silica particles in the mixture of components.

In some embodiments there is provided a method of preparing a water-based coating composition, which includes the steps of: (a) providing a premix including a first amount of water, a solvent, at least one surfactant, a pH adjuster and a plasticizer; (b) providing a binder; (c) adding a defoaming agent to the binder under agitation; (d) adding the premix to the mixture of components under agitation; (e) dissolving a plurality of hydrophobic silica particles in the mixture; (f) adding a second amount of water and a rust inhibitor to the mixture; and (g) adjusting the viscosity of the mixture with a thickening agent.

### DETAILED DESCRIPTION OF THE PREFERRED EMBODIMENTS

As described in detail herein, some embodiments of the present invention provide coating compositions that use nanotechnology, particularly silica particles, to impart corrosion and/or deterioration resistance to surfaces to which they are applied. The coating compositions may be applied to a variety of different surfaces to impart improved properties thereto, including metals and plastics, among others. In some embodiments, the coating compositions may be water-based compositions, and more specifically, water-based paints. The coating compositions may include silica particles, a binder and a solvent, as well as a variety of optional additives, described in detail below.

Coating Compositions

As mentioned above, the coating compositions may include a plurality of silica particles, which may impart desirable coating characteristics to the compositions of the present invention. In some embodiments, the silica particles may be fine particles that are characterized as aerogels. Aerogels are commonly understood to be a highly porous solid formed from a gel. The liquid in aerogels generally is replaced with a gas. Silica aerogels accordingly are a highly porous form of silica particles having a high surface area and large pore volume. The silica particles also may be hydrophobic, i.e., lacking affinity for, or not readily absorbable or dissolvable in, water.

Silica particles may be used in a wide range of particle size and distribution. In some embodiments, the silica particles may have a particle size range of about 5 μm to about 1200 μm. More specifically, some embodiments may have a particle size range of about 5 μm to about 500 μm, and even more specifically about 5 μm to about 15 μm. The pore diameter of the silica particles may be about 20 nm.

A commercially available example of such hydrophobic silica aerogels is sold under the tradename NANOGEL by Cabot Corporation. NANOGEL aerogels are fine silica aerogels, which are free flowing powders. NANOGEL silica aerogels are highly porous and have a fully hydrophobic surface chemistry.

Silica particles may be present in the compositions in amounts of about 0.25% to about 6% by weight of the composition. In some embodiments, silica particles may be present in amounts of about 0.25% to about 1.5% by weight of the composition.

Although silica aerogels are described above, other fine particles having similar chemistry, i.e., hydrophobic aerogels, also may be used in the compositions. For example, commercially available products sold under the tradenames NANOPORE and NANOGLASS by NanoPore, Inc. and commercially available products sold under the tradename PRISTINA by Taasi Corporation may be suitable.

In addition to silica particles, the compositions also may include a binder component. Binders are typically resins used to hold together dried paint or coating formulations. Binders also may assist the coating in adhering to a surface. In accordance with the present invention, the binder may be a polymeric resin. Examples of suitable polymeric resins include, but are not limited to: acrylic resins; vinyl resins; urethane resins; epoxy resins; alkyd resins; silicone resins; UV cure resins; and combinations thereof.

The binder may be present in amounts of about 20% to about 80% by weight of the coating compositions. In some embodiments, the binder may be present in amounts of about 40% to about 60% by weight of the composition.

The coating compositions also may include a solvent. Solvents are generally used in coating or paint formulations to disperse or dissolve solids in the composition. In accordance with the present invention, the solvent may be water or any other suitable solvent, such as organic solvents. Some embodiments of the present invention are water-based coating compositions, and thus, include water as a solvent. Other solvents, such as organic solvents, also may be included. In some embodiments, organic solvents are used in combination with water, whereas other embodiments include organic solvents alone. Examples of suitable organic solvents include, but are not limited to: ethylene glycol monobutyl ether; dipropylene glycol monomethyl ether; dipropylene glycol mono-n-butyl ether; glycol ethers; alcohols; aromatic and aliphatic hydrocarbons; ketones; esters; and combinations thereof

Solvents generally may be present in amounts of about 5% to about 40% by weight of the coating composition. In some embodiments, however, water may be present in amounts of up to about 50% by weight of the composition. More specifically, in some embodiments, solvents may be present in amounts of about 5% to about 15% by weight of the composition.

The coating compositions of the present invention also may include a variety of optional additives. Such components may be added to affect different properties of the composition, such as flow characteristics, among others. For instance, the compositions may include defoaming agents, such as, for example, silicone-based defoaming agents. Defoaming agents may be used to reduce the amount of bubble formation in the compositions during, for example, mixing stages.

Commercially available defoaming agents include those sold under the tradename SURFYNOL by Air Products and Chemicals, Inc., particularly SURFYNOL DF-58. Another example of commercially available defoaming agents include those sold under the trade name DREWPLUS, particularly DREWPLUS L-108, by Ashland Inc. Yet another example of a commercially available defoaming agent is sold under the tradename BYK-022 by BYK-Chemie USA.

Defoaming agents may be present in amounts of 0% to about 3% by weight of the composition. More specifically, defoaming agents may be present in amounts of about 0.25% to about 1.5% by weight of the composition.

Surfactants also may be added to the compositions of the present invention. Surfactants may be used to assist in the dispersion of the hydrophobic silica particles in the composition. Similarly, dispersants and/or wetting agents also may be incorporated to assist in dispersion. In some embodiments non-ionic surfactants may be employed, such as, but not limited to: polyether modified poly-dimethyl-siloxanes; fluoro surfactants; and combinations thereof. Commercially available surfactants include those sold under the tradename SURFYNOL by Air Products and Chemicals, Inc., particularly SURFYNOL 104 BC. Surfactants may be present in amounts of 0% to about 3% by weight of the composition. More specifically, surfactants may be present in amounts of about 0.25% to about 1.5% by weight of the composition.

The compositions further may include a pH adjusting agent. In some embodiments, the pH adjusting agent may be a base. Examples of suitable bases for use as pH adjusting agents include, but are not limited to: aqua ammonia; 2-amino-2-methyl-1-propanol; triethylamine; dimethylethanolamine; and combinations thereof. In some embodiments, pH adjusting agents may be present in amounts of 0% to about 2.5% by weight of the composition. More specifically, pH adjusting agents may be present in amounts of about 0.25% to about 1.5% by weight of the composition.

Another optional additive for incorporation into the coating compositions is a plasticizer. Examples of suitable plasticizers for use herein include, but are not limited to: dibutyl phthalate; dioctyl phthalate; butyl benzyl phthalate; and combinations thereof. Plasticizers may be present in amounts of 0% to about 2% by weight of the composition. More specifically, plasticizers may be present in amounts of about 0.25% to about 1.5% by weight of the composition.

The compositions also may include thickening agents, such as, for example, a hydrophobically modified alkali-soluble emulsion. Thickening agents may be used to adjust the viscosity of the composition. Commercially available thickening agents include those sold under the tradename UCAR POLYPHOBE by Union Carbide, particularly UCAR POLYPHOBE TR-115. Thickening agents may be present in amounts of 0% to about 5% by weight of the composition. More specifically, thickening agents may be present in amounts of about 1% to about 5% by weight of the composition.

Other additives, such as pigments, rust inhibitors, such as RAYBO 60 (commercially available from Raybo Chemical Co.), fire retardants, carbon fibers, dispersants, such as TAMOL 165 (commercially available from Rohm and Haas Co.), coalescents, such as 2,2,4-trimethyl-1,3-pentanediol monoisobutyrate (commercially available as TEXANOL from Eastman Chemical Co.), and combinations thereof, among others, also may be included. Such additives may be incorporated to impart a variety of different properties to the coating compositions. For instance, in some embodiments, the incorporation of carbon fibers may be desired to add strength and durability to the compositions.

In accordance with the above, some embodiments are directed to water-based paint compositions. In water-based paint embodiments, a variety of different pigments may be used to give the paint the desired color. In some embodiments, water-based paint compositions may include an acrylic resin binder, a plurality of hydrophobic silica aerogels, an organic solvent, water and a pigment to provide the desired color. Water-based paint compositions also may contain optional additives, such as, but not limited to, defoaming agents, surfactants, plasticizers, pH adjusting agents, thickening agents, rust inhibitors, fire retardants, carbon fibers, dispersants and/or coalescents, as described above.

Corrosion Resistance

Standard measurements of the corrosion resistance of various coated materials are currently performed using salt spray (fog) test procedures, such as those set forth in ASTM B 117-03 herein incorporated by reference. The test method may be used to measure corrosion resistance of materials such as metals coated with paints or organic coatings. This test method provides a controlled corrosive environment in which specimens are exposed to a salt spray, or fog. More specifically, specimens are prepared and suspended in a closed chamber. The coating on the specimens is scribed, i.e., cut through to the base substrate, prior to placement in the chamber. Inside the chamber, the specimens are exposed to a flow of fog through the chamber, which is created by a continuous spray of a 5% salt solution at a temperature of about 95° F. Corrosion resistance is measured by the number of hours required to undercut the coating a specified distance from the scribed line.

The coating compositions of the present invention, for example, may have a corrosion resistance of about 4000 to about 5000 hours when applied to a substrate and subjected to such salt spray (fog) testing. In some embodiments, for example, the coating composition may have a corrosion resistance of about 4800 hours.

Resistance to Deterioration

Standard measurements of the resistance to deterioration of various coating are currently performed using accelerated weathering test procedures, such as those set forth in ASTM D 4587-01 herein incorporated by reference. The test method reproduces damage caused by sunlight, heat and water. The test may be used to measure deterioration of various paints and related coatings.

More specifically, coated specimens are positioned in a fluorescent UV apparatus. Within the apparatus, the coated specimens are exposed to alternating cycles of UV light and condensation at elevated temperatures. Results are based on the time or exposure necessary to produce a defined property change, i.e., degraded property, in the specimen.

The coating compositions of the present invention, for example, may resist deterioration for about 2500 to about 5000 hours when applied to a substrate and subjected to such accelerated weathering testing. In some embodiments, for example, the coating composition may resist deterioration for about 2600 hours.

Methods of Preparing and Using Coating Compositions

The present invention also is directed to methods of preparing the coating compositions described above, as well as methods of imparting corrosion resistance to coated surfaces. In some embodiments, the coating compositions may be water-based, such as, for example, water-based paints.

In accordance with some embodiments of the present invention, a method of preparing a coating composition includes providing a premix, which contains solvent(s), such as water and/or an organic solvent. Other optional additives that may be included in the premix are surfactants, pH adjusters and plasticizers. Separately, a binder is provided. The binder may be any suitable binder, such as a polymeric resin, as described above. The premix may be added to the binder under agitation. For example, the premix and binder may be mixed together for about 10 minutes. In some embodiments, defoaming agents may be added to the binder under agitation prior to the addition of the premix. The defoaming agents may be mixed with the binder for about 10 minutes. Once the premix has been fully added, a plurality of silica particles may be dissolved in the mixture. The silica particles may be slowly added under agitation over a period of about 15 minutes to disperse the particles in the mixture.

In some embodiments, once the silica particles are dissolved or dispersed in the mixture, an additional amount of water may be added with a rust inhibitor. The viscosity of the mixture then may be adjusted with, for example, a thickening agent. In accordance therewith, it may be desirable to increase the viscosity of the composition depending on the desired end-use. Further, if a colored paint composition is desired, at least one pigment may be added to shade the composition to the desired color. Again, the viscosity may be adjusted by addition of a thickening agent, as needed. Other optional additives, such as fire retardants, carbon fibers, dispersants and/or coalescents, also may be added to the composition during any of the various mixing stages.

The present invention also is directed to methods of imparting corrosion resistance to a surface. An object having a surface to be coated is first provided. The surface may be metal or plastic, among others. A variety of different objects may be coated, including, for example, aluminum fixtures, steel joists, airplane parts and signs, among many others. The composition may be used as a primer or a paint.

The coating composition, which may be water-based, such as, a water-based paint, is provided. In accordance therewith, the coating composition may contain a binder and solvent(s). The solvent(s) may include water and/or an organic solvent. The composition also may include a plurality of hydrophobic silica particles. In addition, the composition may contain one or more optional additives, such as, but not limited to: defoaming agents; surfactants; pH adjusters; thickening agents; plasticizers; rust inhibitors; pigments; fire retardants; carbon fibers; dispersants; and/or coalescents. Once prepared, the composition may be applied to the object's surface to impart corrosion resistance and other performance advantages thereto. The composition may be applied to the surface in any conventional manner including, for example, dip-coating or brushing, rolling or spraying the composition onto the surface.

### EXAMPLES

### Example 1

A water-based composition was prepared in accordance with the present invention. Table 1 below lists the weight percents for each component contained in the composition.

TABLE 1

| Component | Weight % |
|---|---|
| Acrylic resin¹ | 50.49 |
| Defoaming agent | 0.53 |
| Water | 32.24 |
| Ethylene glycol monobutyl ether | 10.68 |
| Surfactants | 0.67 |
| Aqua ammonia | 0.61 |
| Dibutyl phthalate | 0.65 |
| Silica aerogels² | 0.71 |
| Rust inhibitor | 0.49 |
| Thickening agent | 2.93 |

¹MAINCOTE HG-86, available from Rohm and Haas Co.
²NANOGEL 07N aerogels, available from Cabot Corp.

The composition was prepared by first adding the defoaming agent to the acrylic resin binder. The defoaming agent and acrylic resin were mixed for about 10 minutes using a Cowles dissolver with a disperser blade. A premix of a first portion of the water, ethylene glycol monobutyl ether, surfactants, aqua ammonia (as a pH adjuster) and dibutyl phthalate (as a plasticizer) was prepared. The premix then was added to the mixture of the acrylic resin and defoaming agent under agitation. The mixture was mixed for about 10 minutes. The silica aerogels then were slowly added to the mixture. The blade on the mixing apparatus was changed to a Norblade Polymer Impeller. The silica particles were mixed and dissolved into the batch over a period of about 15 minutes. Once the silica aerogels were dissolved, a second portion of the water and the rust inhibitor were added to the mixture. The viscosity of the mixture then was adjusted by adding the thickening agent.

Once the composition was prepared, it was pigmented to form a water-based paint. The components and weight percents in the water-based paint are listed in Table 2 below.

TABLE 2

| Component | Weight % |
|---|---|
| Composition of Table 1 | 95.90 |
| Black pigment | 3.57 |
| Thickening agent | 0.53 |

The black pigment was added to the composition of Table 1 to shade the composition to a black paint. The viscosity then was again adjusted with a thickening agent to form the final product. The viscosity of the paint was approximately 24-27 seconds in a Zahn viscosity cup #4.

The water-based paint then was subjected to corrosion resistance testing and accelerated weathering testing, as described above.

### Example 2

A water-based composition was prepared in accordance with the present invention. Table 3 below lists the weight percents for each component contained in the composition.

TABLE 3

| Component | Weight % |
|---|---|
| Acrylic resin¹ | 42.33 |
| Defoaming agent | 0.6 |
| Water | 37.48 |
| Ethylene glycol monobutyl ether | 8.96 |
| Surfactant | 0.15 |
| Aqua ammonia | 0.41 |
| Dibutyl phthalate | 0.54 |
| Silica aerogels² | 4.66 |
| Rust inhibitor | 0.41 |
| Dispersant | 0.83 |
| Black pigment | 3.63 |

¹MAINCOTE HG-86, available from Rohm and Haas Co.
²NANOGEL 07N aerogels, available from Cabot Corp.

The composition was prepared by first combining a first portion of the water, a first portion of the ethylene glycol monobutyl ether, dispersant, surfactant, aqua ammonia (as a pH adjuster), black pigment and a first portion of the defoaming agent. The components were mixed for about 15 minutes in a Cowles disperser using a disperser blade.

The acrylic resin was provided in a separate mixing tank. The mixture of components from above was added to the acrylic resin under agitation. Also added to the acrylic resin under agitation were the following: a second portion of ethylene glycol monobutyl ether, dibutyl phthalate (as a plasticizer), aqua ammonia, a second portion of the water, a second portion of the defoaming agent and the rust inhibitor. The mixture was mixed for about 10 minutes. The silica aerogels then were slowly added to the mixture. The blade on the mixing apparatus was changed to a Norblade Polymer Impeller. The silica particles were mixed and dissolved into the batch over a period of about 15 minutes.

The viscosity of the final water-based paint was approximately 60-70 KU.

The water-based paint then was subjected to corrosion resistance testing and accelerated weathering testing, as described above. The results were as follows: 4000 hours salt fog resistance per ASTM B 117-03; and 5000 hours accelerated weathering (also referred to as “QUV resistance”) per ASTM D 4587.

### Example 3

A water-based composition was prepared in accordance with the present invention. Table 4 below lists the weight percents for each component contained in the composition.

TABLE 4

| Component | Weight % |
|---|---|
| Acrylic resin¹ | 58.05 |
| Defoaming agents² | 0.71 |
| Water | 13.42 |
| Dipropylene glycol monomethyl ether³ | 2.01 |
| Dipropylene glycol mono-n-butyl ether⁴ | 3.77 |
| Surfactant | 0.2 |
| Aqua ammonia | 0.5 |
| Dibutyl phthalate | 0.75 |
| Silica aerogels⁵ | 3.54 |
| Rust inhibitor | 0.56 |
| Dispersant | 0.9 |
| Coalescent | 0.5 |
| White pigment (titanium dioxide) | 15.09 |

¹MAINCOTE HG-86 (available from Rohm and Haas Co.)
²BYK-022 (available from BYK Chemie USA) and DREWPLUS L-108 (available from Ashland Inc.)
³DOWANOL DPM (available from the Dow Chemical Co.)
⁴DOWANOL DPnB (available from the Dow Chemical Co.)
⁵NANOGEL 07N aerogels (available from Cabot Corp.)

The composition was prepared by first combining a first portion of the water, dipropylene glycol monomethyl ether, dispersant, surfactant, aqua ammonia (as a pH adjuster), white pigment and a defoaming agent (BYK-022). The components were mixed in a Cowles disperser using a disperser blade to a 6 Hegman grind.

The acrylic resin, a second portion of the water and a second portion of the aqua ammonia were provided in a separate mixing tank. The mixture of components from above was added under agitation. Also added under agitation were the following: dipropylene glycol mono-n-butyl ether, the coalescent, dibutyl phthalate (as a plasticizer), a third portion of the aqua ammonia, a third portion of water, another defoaming agent (DREWPLUS L-108) and the rust inhibitor. The mixture was mixed for about 10 minutes. The silica aerogels then were slowly added to the mixture. The blade on the mixing apparatus was changed to a Norblade Polymer Impeller. The silica particles were mixed and dissolved into the batch over a period of about 15 minutes.

The water-based composition then was subjected to corrosion resistance testing and accelerated weathering testing, as described above. The results were as follows: 4800 hours salt fog resistance per ASTM B 117-03; and 2600 hours accelerated weathering per ASTM D 4587.

What is claimed is:

1. A water-based coating composition comprising:
a binder;
a plurality of hydrophobic silica particles; and
a solvent.

2. The composition of claim 1, wherein said binder comprises a polymeric resin.

3. The composition of claim 2, wherein said polymeric resin is selected from the group consisting of: acrylic resins; vinyl resins; urethane resins; epoxy resins; alkyd resins; silicone resins; UV cure resins; and combinations thereof.

4. The composition according to claim 1, wherein said binder is present in amounts of about 20% to about 80% by weight of said composition.

5. The composition according to claim 1, wherein said silica particles comprise silica aerogels.

6. The composition according to claim 5, wherein said silica aerogels have a particle size range of about 5 μm to about 1200 μm.

7. The composition according to claim 5, wherein said silica aerogels have a pore diameter of about 20 nm.

8. The composition according to claim 1, wherein said silica particles are present in amounts of about 0.25% to about 6% by weight of said composition.

9. The composition according to claim 1, wherein said solvent comprises water.

10. The composition according to claim 1, wherein said solvent comprises an organic solvent.

11. The composition according to claim 10, wherein said organic solvent is selected from the group consisting of: ethylene glycol monobutyl ether; dipropylene glycol monomethyl ether; dipropylene glycol mono-n-butyl ether; glycol ethers; alcohols; aromatic and aliphatic hydrocarbons; ketones; esters; and combinations thereof.

12. The composition according to claim 1, wherein said solvent is present in amounts of about 5% to about 40% by weight of said composition.

13. The composition according to claim 1, wherein water is present in amounts of about 0% to about 50% by weight of said composition.

14. The composition of claim 1, further comprising at least one defoaming agent.

15. The composition of claim 14, wherein said defoaming agent comprises a silicone-based defoaming agent.

16. The composition of claim 1, further comprising a defoaming agent present in amounts of about 0% to about 3% by weight of said composition.

17. The composition of claim 1, further comprising at least one surfactant.

18. The composition of claim 17, wherein said surfactant comprises a non-ionic surfactant.

19. The composition of claim 17, wherein said surfactant is selected from the group consisting of: polyether modified poly-dimethyl-siloxanes; fluoro surfactants; and combinations thereof.

20. The composition of claim 1, further comprising a surfactant present in amounts of about 0% to about 3% by weight of said composition.

21. The composition of claim 1, further comprising a pH adjusting agent.

22. The composition of claim 21, wherein said pH adjusting agent comprises a base.

23. The composition of claim 21, wherein said pH adjusting agent is selected from the group consisting of: aqua ammonia; 2-amino-2-methyl-1-propanol; triethylamine; dimethylethanolamine; and combinations thereof.

24. The composition of claim 1, further comprising a pH adjusting agent present in amounts of about 0% to about 2.5% by weight of said composition.

25. The composition of claim 1, further comprising a plasticizer.

26. The composition of claim 25, wherein said plasticizer is selected from the group consisting of: dibutyl phthalate; dioctyl phthalate; butyl benzyl phthalate; and combinations thereof.

27. The composition of claim 1, further comprising a plasticizer present in amounts of about 0% to about 2% by weight of said composition.

28. The composition of claim 1, further comprising at least one thickening agent.

29. The composition of claim 28, wherein said thickening agent comprises a hydrophobically modified alkali-soluble emulsion.

30. The composition of claim 1, further comprising at least one thickening agent present in amounts of 0% to about 5% by weight of said composition.

31. The composition of claim 1, further comprising a pigment.

32. The composition of claim 1, further comprising a rust inhibitor.

33. The composition of claim 1, wherein said composition is a water-based paint.

34. The composition of claim 1, wherein said composition is capable of resisting corrosion by fog for about 4000 to about 5000 hours when subjected to salt spray fog testing per ASTM B 117-03.

35. The composition of claim 1, wherein said composition is capable of resisting deterioration caused by exposure to light, heat and water for about 2500 to about 5000 hours when subjected to accelerated weathering testing per ASTM D 4587-01.

36. A water-based paint composition comprising:
an acrylic resin binder;
a plurality of hydrophobic silica aerogels;
an organic solvent;
water;
a pigment; and
one or more components selected from the group consisting of: defoaming agents;
surfactants; plasticizers; pH adjusting agents; thickening agents; rust inhibitors; fire retardants; carbon fibers; dispersants; and coalescents.

37. A water-based coating composition comprising:
a binder;
a plurality of hydrophobic silica particles;
a solvent; and
water,
wherein said composition is capable of resisting corrosion by fog for about 4000 to about 5000 hours when subjected to salt spray fog testing per ASTM B 117-03 and said composition is capable of resisting deterioration caused by exposure to light, heat and water for about 2500 to about 5000 hours when subjected to accelerated weathering testing per ASTM D 4587-01.

38. A method of imparting corrosion resistance to a surface, comprising the steps of:
(a) providing an object having a surface to be coated;
(b) providing a water-based coating composition comprising a binder, a solvent, water, a plurality of hydrophobic silica particles, and optionally one or more components selected from the group consisting of defoaming agents, surfactants, pH adjusters, thickening agents, plasticizers, rust inhibitors, pigments, fire retardants, carbon fibers, dispersants and coalescents; and
(c) applying the water-based coating composition to the surface, thereby imparting corrosion resistance thereto.

39. A method of preparing a water-based coating composition, comprising the steps of:
(a) providing a premix comprising a first amount of water and a solvent;
(b) providing a binder;
(c) adding the premix to the binder under agitation; and
(d) dissolving a plurality of hydrophobic silica particles in the mixture of components.

40. The method of claim 39, wherein the premix of step (a) further comprises one or more components selected from the group consisting of surfactants, pH adjusters and plasticizers.

41. A method of preparing a water-based coating composition, comprising the steps of:
(a) providing a premix comprising a first amount of water, a solvent, at least one surfactant, a pH adjuster and a plasticizer;
(b) providing a binder;
(c) adding a defoaming agent to the binder under agitation;
(d) adding the premix to the mixture of components under agitation;
(e) dissolving a plurality of hydrophobic silica particles in the mixture;
(f) adding a second amount of water and a rust inhibitor to the mixture; and
(g) adjusting the viscosity of the mixture with a thickening agent.

42. The method of claim 41, further comprising the step of adding a pigment to the mixture to form a water-based paint.
